(19) United States
(12) Patent Application Publication
(10) Pub. No.: US 2004/0199600 A1
(43) Pub. Date: Oct. 7, 2004

(54) Method and apparatus for program installation in a modular network

(76) Inventors: Alan D. Dorundo, Boca Raton, FL (US); Chester A. Heath, Boca Raton, FL (US); Ronald Valli, Boca Raton, FL (US); Douglas Haigh, Cary, NC (US)

Correspondence Address: KAPLAN & GILMAN , L.L.P., 900 ROUTE 9 NORTH, WOODBRIDGE, NJ, 07095, US

(21) Appl. No.: 10/272,455

(22) Filed: Oct. 16, 2002

Related U.S. Application Data
(60) Provisional application No. 60/329,638, filed on Oct. 16, 2001.

(51) Int. Cl. G06F 15/167

(52) U.S. Cl. 709/216

(57) ABSTRACT

The present invention provides a method for program installation that is eliminates the need to download the required program to a host computer as an intermediate step to sending the program to the client processor. In the method disclosed, the client processor has the capability of emulating the configuration of a host computer disk interface and so be in a position to receive the requested program directly. After the program is downloaded and installed on the client processor, the emulation is deactivated and normal operating resumes. The invention provides substantially mirror image functionality so that peripheral devices of the host server can be configured to emulate components of the client processor.

### RELATED APPLICATION

This application is a conversion of and obtains the filing date of provisional patent application Ser. No. 60/329,638, filed Oct. 16, 2001.

### FIELD OF THE INVENTION

The present invention relates to the field of clustered remote processor computer systems, and more particularly to a method for the installation of programs into card processors.

### BACKGROUND OF THE INVENTION

The invention disclosed below relates to computer processor systems in which the central processing unit (CPU) of each of a plurality of workstations is configured as a single card “motherboard” with auxiliary function boards, e.g. print drivers, etc. A number of such workstation card processors are mounted in a rack and connected to a host server via a short length high-speed bus. By clustering the cards, there is no need for a locally positioned CPU at each work location, thus economizing on workstation space. Further, the clustered card system permits the several workstations to share memory by segmenting a common memory device into sectors that are individually allocated. This architecture is disclosed in greater detail in U.S. patent application Ser. No. 09/466,463, entitled Modular Architecture For Small Computer Networks, commonly owned by the assignee of this application.

Under the existing system, when a single card client processor is initially installed, its storage must be loaded with applications, operating system software, and other software for it to operate. This involves creating a pseudo removable file and copying and expanding the operating system (OS) image into that file. A first step is downloading the desired program from the outside source, typically over a network, to a storage device associated with the host server. A second step is downloading the program from the host server to the workstation card. A third step is for the workstation card CPU to expand the file and save it to its storage device. This process is often laborious and time consuming, thus reducing the efficiency of the system.

Therefore, it is an object of the present invention to provide an improved method for installing a program to a workstation card device without requiring an intermediate downloading and transfer of the program.

This and other objects will become more apparent from the description of the invention to follow.

### SUMMARY OF THE INVENTION

A method is provided for use in improving the operating efficiency of a single card client processor that is connected in a modular network to a host server. Upon initialization, and after POST completion, the client processor requires one or more programs that are too large to maintain locally. The client processor first sends an emulation transmission to indicate to the host that the client is a disk interface of the host. Upon sending this emulation, the client next requests the needed program, which is provided and installed. At the completion of installation, assuming that no further programs are required, the client sends a second signal to indicate to the host that the client is, once more, a client processor. Normal operation is resumed. Similar emulation is provided to cause a peripheral device connected to the host computer to appear and interact as if it were connected to the client.

Thus, a single board computer is disclosed which, in a first mode, during software loading and initialization, behaves as a disk interface to a remote host, and in a second mode, behaves as an independent computer. Initialization software can be loaded quickly and efficiently, because the storage for the SBC is, effectively, the hard disk of the remote computer. After loading, the SBC switches modes and operates as an independent computer.

### BRIEF DESCRIPTION OF THE DRAWINGS

FIG. 1 is a schematic drawing of a modular computer network in which a plurality of workstation card devices are connected via a bus to a host server.

FIG. 2 is a flow chart depicting the steps for downloading a program to a workstation card emulating a host.

### DETAILED DESCRIPTION OF THE INVENTION

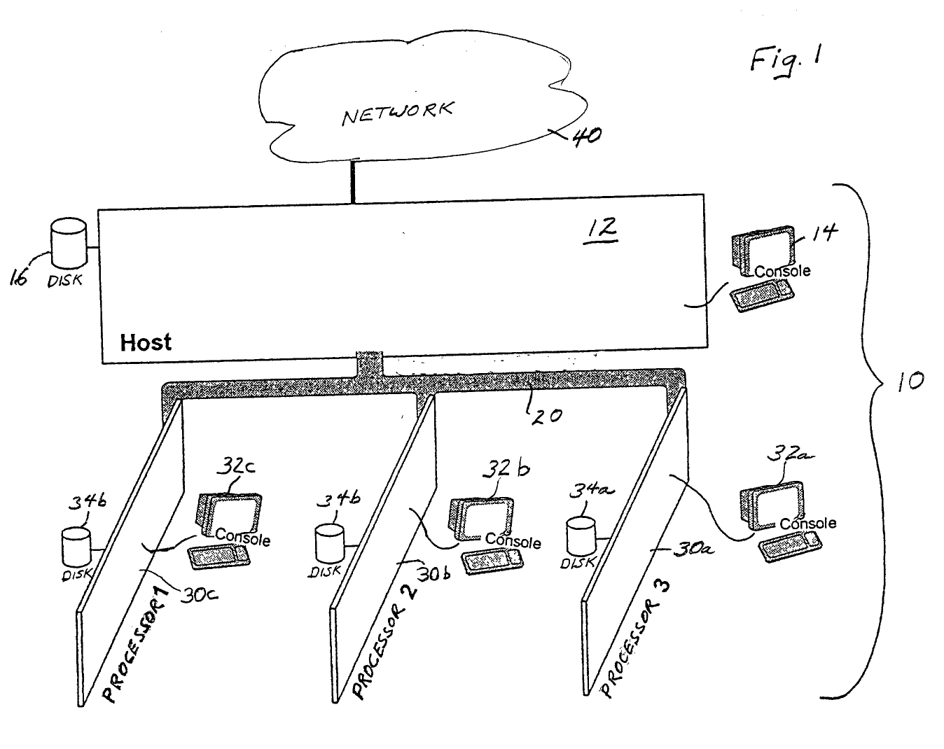

Referring now to FIG. 1, a modular network 10 employing the method of the present invention is illustrated. Network 10 is built with a plurality of single card processors 30a, 30b and 30c being connected in known fashion to a high-speed, short length bus 20 which is in electronic communication with host server 12. Host server 12 includes a console 14, comprising a keyboard and a monitor (not individually numbered) and a storage device, such as disk 16. Host server 12 is also connected to communication network 40, for example being the Internet for communication outside of the local network. Typical processor 30a has peripheral devices connected thereto, for example console 32a and disk 34a. In the typical modular network, console 32a resides at a workstation remote from modular network 10 so that processor 30a and storage device 34a do not occupy workstation space, but are held in a remote modular network rack. In this way, processor 30a can reside in closer proximity to host 12, reducing the required length of bus 20 and thus increasing the resultant speed of information transfer. Rather than providing an individual storage device 34a for each processor 30a, it is common that storage devices 34a, 34b and 34c are actually reserved sectors of a large, commonly accessible storage device. Alternatively, and dependent upon the requirements of the specific system, e.g., security requirements, each processor 30a, 30b and 30c will be connected to a separate storage disk device 34a, 34b and 34c.

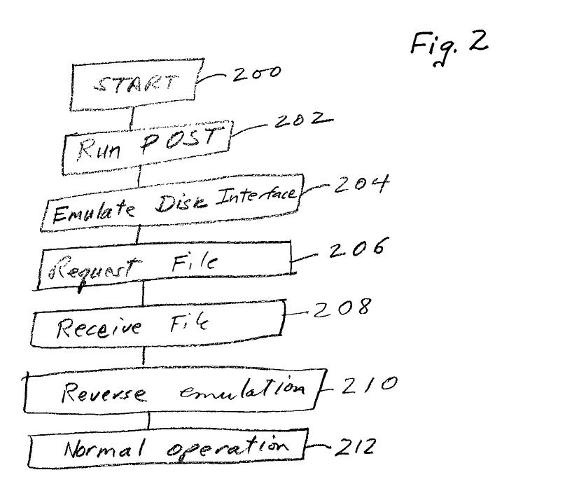

Referring now to FIG. 2, the method of the present invention is illustrated as a flow chart. The single card processor 30a (see FIG. 1) is booted in step 200. Upon activation, the system initiates a power on self test (POST) functionality in step 202. In step 204, the program next transmits a signal to the host server 12 to provide an emulation that the host server disk interface 16 is residing within client processor 30a. Having created the emulation that client processor 30a includes disk interface 16 of host server 12, client processor requests a needed program, e.g., a word processing program, from host server 12 to be downloaded in step 206. Client processor 30a receives the requested program in step 208 and installs same, without the need to wait for the completion of intermediate processing at host server 12. At the completion of the installation process, client processor 30a transmits a second signal to host server 12 in step 210 to cancel the disk interface emulation and indicate that client processor 30a is, once again, client processor 30a. Finally, client processor 30a resumes its normal operation at step 212.

As will be understood by those skilled in the art, the features of component emulation can be implemented in reverse to have peripheral components of the host server appear as to be attached to the client. Thus, for example, a CD reader that is resident on host server 12 can be made directly accessible by client processor 30a, 30b or 30c by causing the CD reader to appear as a peripheral of the respective client processor 30a, 30b or 30c. Similar interaction can be performed with a scanner, printer, etc.

While the present invention is described with respect to a specific embodiment thereof, it is recognized that various modifications and variations may be made without departing from the scope and spirit of the invention, which is more clearly and precisely defined by reference to the claims appended hereto.

What is claimed is:

1. A method for installing a program into a client processor in a modular network, comprising the steps of:
(a) emulating a host server memory device;
(b) requesting a program download to the client processor;
(c) sending the requested program to the client processor; and
(d) installing the requested program in the client processor.

2. The method for installing a program as described in claim 1, wherein the step of emulating comprises transmitting a first signal from the client processor to a host server to cause the host server to perceive the client processor as the host server memory device.

3. The method for installing a program as described in claim 1, further comprising sending a second signal from the client processor to the host server to cause the host server to perceive the client processor as the client processor.

4. The method for installing a program as described in claim 1, wherein the client processor comprises a single card processor connected to a remote keyboard and memory device.

5. The method for installing a program as described in claim 4, wherein the memory device is a sector of a memory between a plurality of single card processors.

6. A modular computer apparatus, comprising:
(a) a host server;
(b) a plurality of client processors;
(c) a high-speed bus connecting the plurality of client processors to the host server; and
(d) wherein at least one of the client processors is configured for emulating a storage device of the host server.

7. The apparatus as described in claim 6, wherein the at least one client processor comprises embedded software capable of transmitting a first signal to the host server to emulate the storage device and transmitting a second signal to cancel such emulation.

8. The apparatus as described in claim 6, wherein the client processor is a single card processor having a user interface that is located remote therefrom.

9. A method for permitting interaction between a first computer device and a second computer device, comprising:
(a) causing a component of the first computer device to emulate a component of the second computer device;
(b) requesting transmission of data between the first and second computer device;
(c) transmitting the requested data from one to the other computer device as requested; and
(d) utilizing the requested data.

10. The method for permitting interaction described in claim 9, wherein the step of causing emulation comprises transmitting a first signal from the first computer device to the second computer device to cause one computer device to perceive the component as its own.

11. The method for permitting interaction described in claim 9, further comprising sending a second signal from the first computer device to the second computer device to cause one computer device to no longer perceive the component as its own.

12. The method for permitting interaction described in claim 9, wherein the first computer device is a host server and the second computer device is a client processor.

13. A method for installing a program into a client processor in a modular network, comprising the steps of:
(a) activating a condition wherein the client processor emulates a host server memory device; and
(b) deactivating the emulation condition to configure the client processor as the client processor.
